(19) United States
(12) Patent Application Publication
(10) Pub. No.: US 2014/0101003 A1
(43) Pub. Date: Apr. 10, 2014

(54) DATA TRACKING BASED ON STATUS

(71) Applicants: Tina Marseille, Walldorf (DE); Carsten Schmitt, Walldorf (DE)

(72) Inventors: Tina Marseille, Walldorf (DE); Carsten Schmitt, Walldorf (DE)

(21) Appl. No.: 13/647,090

(22) Filed: Oct. 8, 2012

(51) Int. Cl. G06Q 40/00

(52) U.S. Cl. 705/30

(57) ABSTRACT

System and methods for tracking data based upon a status. A request for data associated with a status may be received. A set of data structures associated with the status may be determined. The each data structure of the set of determined data structures may be queried for a data element. An output may be generated based upon the returned data elements.

### BACKGROUND

With rapidly expanding businesses, many employees incur various expenses in the performance of their job duties. For example, in some instances an employee may need to travel away from their employer's office as part of their job and/or incur costs during other aspects of their job function. In incurring the expenses, the employee may spend their own money, such as by charging a personal credit card, for which the employer may reimburse the employee. Such expenses may be entered as individual expense items into a travel and expense management system and/or otherwise submitted to the employer. For example, while an employee is travelling the expenses may be entered via a mobile application on a smart phone or tablet computer, the expenses may be documented textually or visually (e.g., an image of a receipt) by an e-mail or other message, or the expenses may be based upon a credit card feed. Such expense items may be added to an expense report for submission for reimbursement.

### SUMMARY

One implementation relates to a method for tracking amount data. The method may include receiving a request for an amount sum associated with a status. A determination may be made of one or more expense report objects associated with the received status. A query may be made of the determined expense report objects associated with the status for an amount data element. The amount data elements may be received and the sum of the amount data elements may be output to a feature of a user interface.

In another implementation, a computer implemented method may include receiving a request for an amount sum associated with a status of one or more expense items. A determination may be made of one or more expense report objects associated with the status. A query may be made for amount data elements of the expense items associated with the status. The queried amount data elements may be received and an amount sum may be output to a feature of a user interface.

In yet a further implementation, a tangible computer-readable medium may include instructions for receiving a first request for a first data sum associated with a first status. A determination may be made of a first set of data structures associated with the first status. A query may be made for a first data element of the first set of data structures. A first output may be generated that is associated with the first status and includes a sum of the returned first data elements. The first output may be then be displayed.

### BRIEF DESCRIPTION OF THE DRAWINGS

Various embodiments taught herein are illustrated by way of example, and not by way of limitation, in the figures of the accompanying drawings, in which:

FIG. 1 is a block diagram of an example computing device;

FIG. 2 is a block diagram of a system having a plurality of computing devices connected to a server via a network;

FIG. 3 is a block diagram of an example expense report object;

FIG. 4 is an example process for tracking data based on status; and

FIG. 5 is an overview of an example expense report homepage user interface having a feature for tracking data based on status.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

In some instances, it may be useful to a user to present data based on a status of an associated object. For example, in the context of an expense reporting application, it may be useful to know the amount of money a user has spent, but has not yet submitted for reimbursement and/or that which has been submitted, but not yet approved. Such data tracking may be useful for an employee because the employee may take action to submit any expenses that have been entered, but not yet submitted and/or the employee may send a reminder or otherwise follow-up on expenses that have been submitted, but not yet approved. For an employer, it may be useful to determine the total outstanding money such that the employer may reimburse employees quickly to keep outstanding expenditures to a minimum. In some versions, it may be useful to aggregate the totals such that an employee and/or an employer may be presented with a single value of outstanding money without having to aggregate each individual outstanding expense. In some versions, the totals may be presented as part of a user interface that the user can quickly view and determine the total money outstanding.

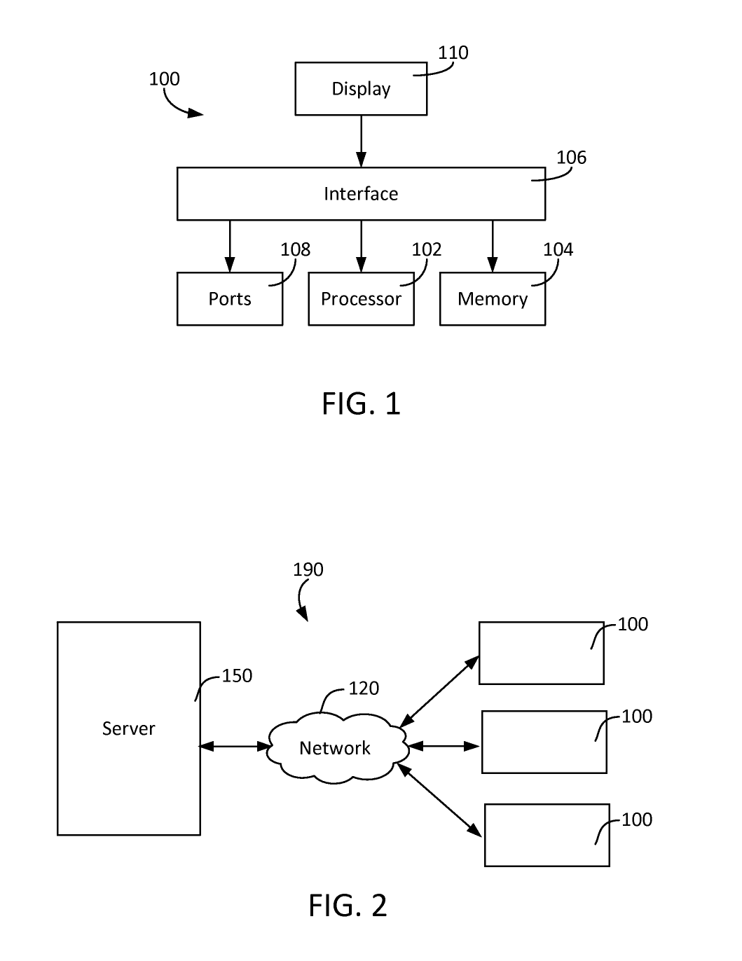

FIG. 1 is a block diagram of a computing device 100 that may be used to implement the systems and methods in accordance with the implementations described herein, as either a client or as a server or plurality of servers. Computing device 100 may include, but is not limited to, digital computers, such as laptops, desktops, workstations, personal digital assistants, servers, blade servers, mainframes, cellular telephones, smart phones, mobile computing devices (e.g., a notepad, e-reader, tablet, netbook, etc.), etc.

Computing device 100 includes a processor 102, memory 104, an interface 106 and ports 108. Each of the components 102, 104, 106, and 108, are interconnected using various busses, and may be mounted on a common motherboard or in other manners as appropriate. The processor 102 can process instructions for execution within the computing device 100, including instructions stored in the memory 104 to display graphical information for a GUI on an external input/output device, such as display 110 coupled to interface 108.

In other implementations, multiple processors and/or multiple buses may be used, as appropriate, along with multiple memories and types of memory. Also, multiple computing devices 100 may be connected, with each device providing portions of the necessary operations (e.g., as a server bank, a group of blade servers, a multi-processor system, etc.). The ports 108, which may include various communication ports (e.g., USB, Bluetooth, Ethernet, wireless Ethernet, etc.), may be coupled to one or more input/output devices, such as a keyboard, a mouse, a pointing device, a scanner, etc., or a networking device (a switch, adapter, bridge, router, hub, repeater, etc.).

The processor 102 may provide, for example, for coordination of the other components of the device 100, such as control of user interfaces, applications run by device 100, and wireless communication by device 100. Processor 102 may communicate with a user via interface 106 (e.g., control, display, external, etc.), coupled to a display 110. The display 110 may be, for example, a TFT (Thin-Film-Transistor Liquid Crystal Display) display, an OLED (Organic Light Emitting Diode) display, other flexible display, etc. The interface 106 may include circuitry for driving the display 110 to provide graphical, textual, and other information to a user. The interface 106 may receive commands (e.g., voice-activated, text, etc.), from a user and convert them to provide to the processor 102.

In addition, the interface 106 may be provided to communicate with processor 102 and enable near area communication of device 100 with other devices. The interface 106 may provide, for example, for wired communication. In some implementations, multiple interfaces may be used. Computing device 100 may communicate wirelessly through interface 106, which may include digital signal processing circuitry where necessary. Interface 106 may provide for communications under various modes or protocols, such as GSM voice calls, SMS, EMS, or MMS messaging, CDMA, TDMA, PDC, WCDMA, CDMA2000, or GPRS, etc. Such communication may occur, for example, through a radio-frequency transceiver. In addition, short-range communication may occur, such as using a Bluetooth, WiFi, or other such transceiver. In addition, GPS (Global Positioning System) receiver module may provide additional navigation- and location-related wireless data to device 100, which may be used as appropriate by applications running on device 100. The device 100 may also be provided with a storage device to provide additional storage, e.g., solid-state flash media. Each of the components may be interconnected using various buses. Several of the components may be mounted on a common motherboard or in other appropriate manners.

The memory 104 stores information within the computing device 100. In one implementation, the memory 104 is a volatile memory unit or units. In another implementation, the memory 104 is a non-volatile memory unit or units. In yet another, the memory 104 comprises both volatile memory units and non-volatile memory units. The memory 104 may also be another form of computer-readable medium, such as a magnetic or optical disk. The memory 104 may be capable of providing mass storage for the computing device 100. In one implementation, the memory 104 may be or contain a computer-readable medium, such as a floppy disk, CD-ROM, DVD, magnetic disk, memory chip, ROM, RAM, EEPROM, EPROM, flash memory or other similar solid state memory device, or an array of devices, including devices in a storage area network or other configurations.

A computer program product may be tangibly embodied in an information carrier. The computer program product may also contain instructions that, when executed, perform one or more methods, such as those described below. The information carrier is a computer or machine-readable medium, such as the memory 104, memory on processor 102, a propagated signal, etc. Expansion memory may be provided and connected to device 100 through interface 106.

Referring to FIG. 2, in some versions, a plurality of computing devices 100 may be connected to one or more servers 150 via a network 120 to form a system 190. Network 120 may be any form of computer network that relays information between computing devices 100 and server 150. For example, network 120 may include the Internet and/or other types of data networks, such as a local area network (LAN), a wide area network (WAN), a cellular network, satellite network, or other types of data networks. Network 120 may also include any number of computing devices (e.g., computer, servers, routers, network switches, etc.) that are configured to receive and/or transmit data within network 120. Network 120 may further include any number of hardwired and/or wireless connections. For example, computing devices 100 may communicate wirelessly (e.g., via WiFi, cellular, radio, etc.) with a transceiver that is hardwired (e.g., via a fiber optic cable, a CAT5 cable, etc.) to other computing devices in network 120.

Server 150 may also be any number of different types of electronic devices configured to communicate via network 120 (e.g., a laptop computer, a desktop computer, a tablet computer, a smart phone, a server, combinations thereof, etc.). Server 150 may be configured in substantially the same way as computing device 100 or server 150 may have other configurations. Server 150 may include a processor and a memory, i.e., a processing circuit. The memory may store machine instructions that, when executed by the processor cause the processor to perform one or more of the operations described herein. The processor may include a microprocessor, ASIC, FPGA, etc., or combinations thereof. The memory may include, but is not limited to, electronic, optical, magnetic, or any other storage or transmission device capable of providing the processor with program instructions. The memory may include a floppy disk, CD-ROM, DVD, magnetic disk, memory chip, ROM, RAM, EEPROM, EPROM, flash memory, optical media, or any other suitable memory from which the processor can read instructions.

In some versions, system 190 may be implemented and/or integrated into an enterprise architecture. Of course, system 190 is merely and example and other systems may be used with the methods and processes described herein.

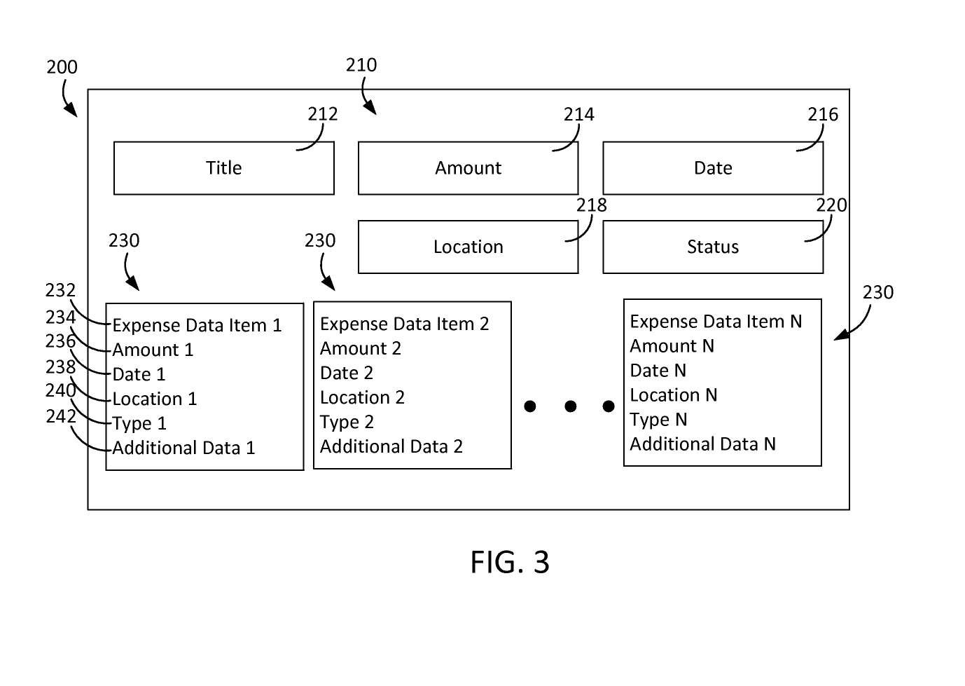

As discussed above, it may be useful to track data based on a status of an object associated with the data. Referring to FIG. 3, one such object that may include data that may be useful to be tracked based upon a status is an expense report object 200. In the present example, expense report object 200 includes one or more data elements 210 associated with expense report object 200 and one or more associated expense items 230.

An example expense item 230 includes a plurality of data elements, including a title 232, an amount 234, a date 236, a type, 238, a location 240, and any additional data 242. Any of the foregoing data may be omitted, altered, added, or otherwise for each expense item 230. In some instances, expense items 230 may be automatically generated. For example, a credit card feed may be monitored and each transaction may result in the generation of an expense item 230. The plurality of data elements may also be automatically entered by the automated system for each expense item 230 based upon the information in the credit card feed and/or through other automated processes. For example, the credit card feed may include a location for the transaction, a date, an amount, and other data. Such items may be utilized for amount 234, date 236, location 240, and/or additional data 242. In addition, in some versions a title 232 and a type 238 may be generated based upon a title for the credit card transaction, based upon a type of establishment associated with the transaction and/or other data (e.g., a restaurant transaction at 7 P.M. may be indicative of a dinner meal type expense, a hotel transaction with a credit card transaction title include the word “room” may be indicative of a lodging type expense). In other versions, image files for scanned receipts may have optical character recognition performed on the image to extract data from the receipt to generate each expense item and/or any or all of the plurality of data elements. In other versions, expense item 230 and/or the plurality of data elements may be manually created by a user. Still other ways of generating expense items 230 and/or inputting one or more of the plurality of data elements may be implemented.

In some instances, one or more of the expense items 230 may be automatically associated with expense report object 200. In some instances, the automatic association of an expense item 230 with expense report object 200 may be based upon one or more rules using one or more of the plurality of data elements of the expense item 230 and the one or more data elements 210 associated with expense report object 200. For instance, if expense report object 200 has one or more associated dates 216 (e.g., Jan. 1, 2012 through Jan. 4, 2012), an expense item 230 having a date 236 on or within the range of the one or more dates 216 of expense report object 200 may be automatically associated with that expense report object 200. In other versions, the location 240, amount 234, type 238, and/or other data elements of the expense item 230 may be used with one or more data elements 210 of expense report object 200 to automatically associate the expense item 230 with expense report object 200. Of course, other information for such automatic association may be utilized as well.

Data elements 210 of expense report object 200 may include a title 212, an amount 214, a date 216, a location 218, and a status 220. Title 212 may be a user defined title generated when the expense report object 200 is created. In other versions, title 212 may be automatically generated when expense report object 200 is created and/or otherwise. Amount 214 comprises a sum of amounts 234 of expense items 230 associated with expense report object 200. Date 216 may comprise a user-defined date and/or date range or, in some versions, date 216 may be defined based upon one or more dates 236 of one or more expense items 230 associated with expense report object 200. By way of example only, first date from a first expense item 230 may be used for a first end of a date range and a second date from a second expense item 230 may be used for a second end of a date range such that the remaining dates of the other expense items 230 are between the two ends of the date range. Of course, other implementations to determine date 216 of expense report object 200 may be used. Location 218 may comprise a user-defined location or, in some versions, location 218 may be defined based upon one or more locations 240 of one or more expense items 230 associated with expense report object 200.

Status 220 of expense report object 200 may include an indicator of the status of expense report object 200. By way of example only, status 220 may include indicators such as “Not Submitted,” “Pending Approval,” “Approved,” “Paid” or the like. In some versions, status 220 may be manually changed by one or more users interacting with expense report object 200 and/or status 220 may be automatically changed based on one or more other interactions. For example, status 220 may be changed from “Approved” to “Paid” in response to a transaction from a payroll system. In other versions, status 220 may be automatically changed from “Not Submitted” to “Pending Approval” once a user submits expense report item 200 for approval. In some versions, status 220 may change automatically from “Pending Approval” to “Approved” in response to an approval script. For instance, an expense report object 200 may be associated with a pre-approval request that may automatically approve the expense report object 200 so long as one or more rules are met (e.g., does not exceed a certain value or the like.). Of course, other features for status 220 may be provided.

In some instances, one or more of the expense items 230 may not be automatically associated with an expense report object 200. Such a situation may arise if no expense report object 200 exists to automatically associate the expense item 230 or if other user input is needed for the expense item 230 (e.g., adding in additional data, approving the addition of expense item 230, or the like). In such a situation, the unassigned expense item 230 may be added to an expense buffer. The expense buffer may include any number of unassigned expense items 230 or may have no expense items. It should be understood that the expense buffer contains any expense items 230 that have been created, but have not been assigned or associated with an expense report object 200. In some implementations, additional data 242 may include a status of such expense items 230 in the expense buffer may be set as “Unassigned.”

In still another version, one or more expense items 230 may be added to a non-reimbursable buffer. For example, one or more expense items 230 may result from an expense that an employer either does not reimburse and/or the expense may be a personal expense. Such expense items 230 may thus be added to the non-reimbursable buffer in order to still keep track of the expense items 230 while not associating the expense items 230 with an expense report object 200 or leaving the expense items 230 in the expense buffer. In some implementations, additional data 242 may include a status of such expense items 230 in the non-reimbursable buffer may be set as “Non-Reimbursable.” In some versions, expense items 230 in the non-reimbursable buffer may be deleted after a predetermined time (1 or more days, 1 or more weeks, 1 or more months, 1 or more years, etc.).

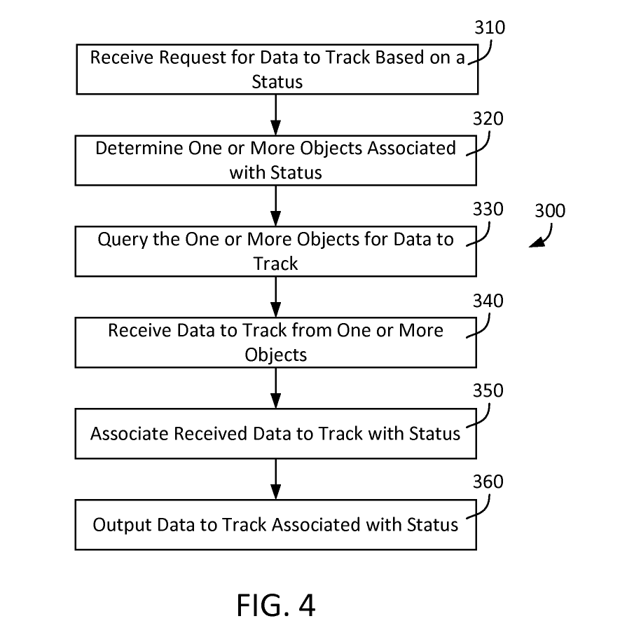

FIG. 4 depicts an example process 300 for outputting tracked data associated with a status of an object. In some implementations, a request for data to be tracked based upon a status may be received (step 310). For example, for an expense report having a status associated with the expense report, such as expense report object 200 having associated status 220 shown in FIG. 2, a request may be made for data for all expense reports having a status of “Pending Approval,” “Approved,” “Not Submitted,” and/or “Paid.” Thus, a request may be made to return data for each status category. In some versions, data may be returned for a combination of any or all of the foregoing status categories (e.g., “Not Submitted” and “Pending Approval,” “Approved” and “Paid,” etc.). In some other implementations, the request for data to be tracked based upon a status may be for one or more expense items 230. For example, one or more expense items 230 may not be associated with an expense report object 200. Such expense items 230 may instead be associated with an expense buffer that includes all expense items 230 that have not been associated with an expense report object 200. Accordingly, in some instances it may be useful to request the amount of unassigned expense items 230 to determine how much money has not been associated with any expense report object 200. Thus, such expense items 230 may be associated with a status of “Unassigned” of additional data 242. In still another version, it may be useful to request the amount of non-reimbursable expense items 230 to determine how much money has will not be reimbursed. Such expense items 230 may be associated with a status of “Non-Reimbursable” of additional data 242. Still other requests for data to track based on a status may be received in other contexts.

In some implementations, one or more objects may be determined having the associated status (step 320). For example, expense report objects 200 having an associated status 220 corresponding to the status on which the request is based may be determined based upon a query of a database or list of expense report objects 200. In other versions, one or more expense items 230 having an associated status (e.g., as additional data 242 or otherwise) corresponding to the status on which the request is based may be determined based upon a query of all the expense items 230, one or more buffers (e.g., the expense buffer, the non-reimbursable buffer, etc.) and/or otherwise.

Having determined the set of one or more objects associated with the status, a query may be made of the determined set of objects for the requested data to track. For example, in the example of expense report object 200 having associated status 220 and amount 214, a query for an amount 234 and/or for the sum of amounts 234 of expense items 230 may be made for each expense report object 200 of the determined set of expense report objects 200 (step 330). Of course, other data associated with the expense report object 200 may be queried as well (e.g., dates 216, locations 218, and/or other data). In some versions, such as in the case of expense items 230 having an associated status of “Unassigned” or “Non-Reimbursable”, a query for an amount 234 and/or for a sum of amounts 234 of the expense items 230 may be made. Of course, other data associated with the expense items 230 may be queried as well (e.g., dates 236, types 238, locations 240, and/or other data).

The data of each object of the determined set may be received (step 340) and may be associated with the status (step 350). In some instances, the received data may be aggregated to form a single sum of the data returned. For example, a sum of the amounts 214 from each expense report object 200 may be aggregated such that a total sum may received in response to the request for data to track. In other versions, the data may be returned as an array or other listing of the individual values. Still other ways to return the queried data may be implemented. The received data may be associated with the status. For example, the sum of amounts 214 of expense report objects 200 that each may have the status of “Not Submitted” may be received and associated with the status “Not Submitted.” Of course, other statuses and/or other data for expense report objects 200 and/or expense items 230 may be associated as well.

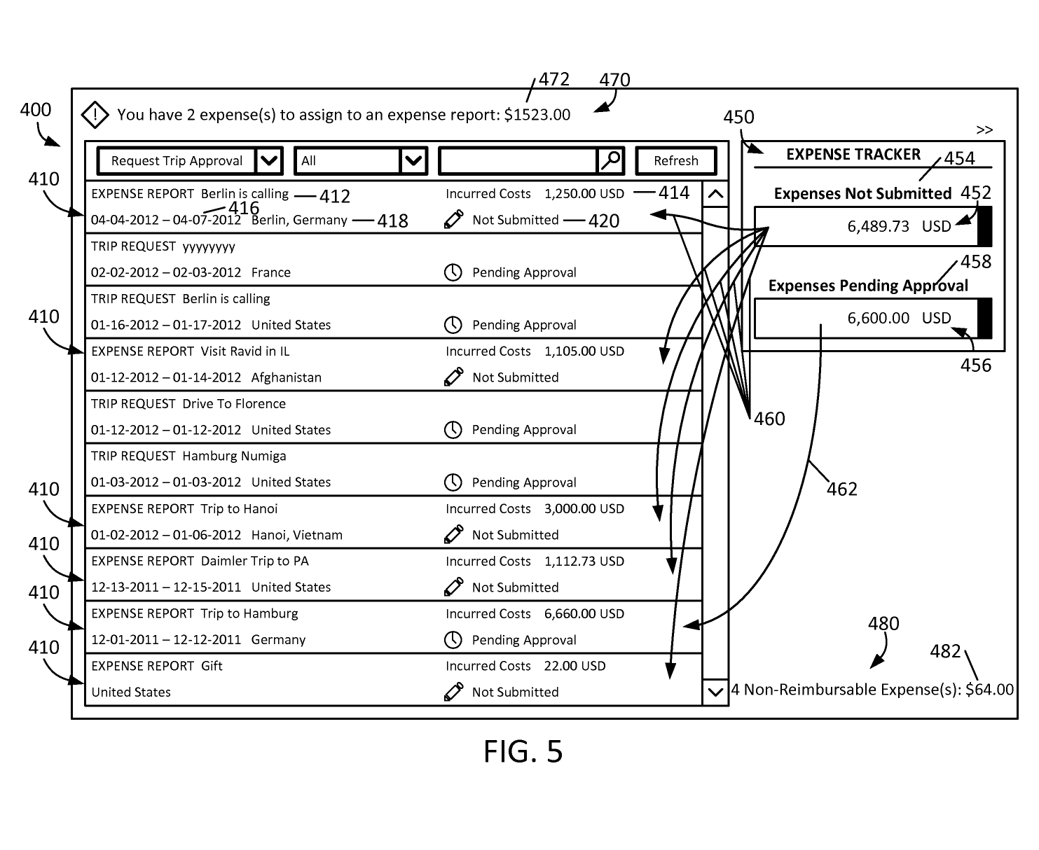

In some instances, the received data associated with the status may be output (step 360). For example, the sum of amounts 214 from the expense report objects 200 each having the status 220 of “Not Submitted” may be associated with the status “Not Submitted” and output to a user interface for display and/or other presentation to a user. In some instances, such as that shown and described in relation to FIG. 5, the output may be utilized with a user interface such that a user may view the output data to track as part of a homepage user interface 400 for an expense reporting application, such as via expense tracker feature 450. In still further implementations, the output of the data to track may be sent to another application, such as an accounting application or otherwise, to track data related to a status. For example, it may be useful to output the sum of amounts having a status of “Paid” for keeping track of payments to an entity (e.g., an employee, department, division, etc.) for certain types of payments (e.g., meals, lodging, travel, etc.) and/or otherwise.

In some instances, a notification may be sent to the user via e-mail or another notification method (Facebook®, Twitter®, etc.) based on the output. In some implementations, a threshold value may be utilized such that when the tracked data exceeds the threshold, a notification may be sent to the user and/or another process may be triggered. By way of example only, if the value for expenses not submitted exceeds a certain value, such as $10,000, a notification may be sent to a user or third-party and/or a hold on reimbursement may be put in place until the user decreases the value of the tracked data. Of course, other implementations and/or uses for the output of tracked data based on status may be implemented.

One or more steps may be omitted, modified, added and/or otherwise for process 300 and/or process 300 may be used in other contexts.

FIG. 5 depicts an example homepage user interface 400 having some example implementations of process 300. In the present example, user interface 400 includes a plurality of displayed expense report objects 410, displayed trip request objects, an expense report assignment feature, a new report feature, a sorting feature, a search feature, a refresh feature, an expense tracker feature 450, an expense buffer feature 470, and a non-reimbursable expenses feature 480. In the present example, displayed expense report objects 410 are an entry displaying one or more of the data elements associated with the expense report object 410. As shown in FIG. 5, merely example data elements that may be displayed include a title 412, an amount 414, a date 416, a location 418, and a status 420. Expense report object 410 may be further configured in accordance with at least some of the teachings of expense report object 200 described herein.

In the present example, status 420 of an example displayed expense report object 410 may include an indicator of the status of expense report object 410. By way of example only, status 420 may include indicators such as “Not Submitted,” “Pending Approval,” “Approved,” “Paid” or the like. In some versions, status 420 may be manually changed by one or more users interacting with expense report object 410 and/or status 420 may be automatically changed based on one or more other interactions, such as those described in reference to status 220 herein.

Referring to expense tracker feature 450, one or more outputs as a result of process 300 may be displayed by expense tracker feature 450. In the example shown, an output 452 of the aggregate of tracked data for a status of “Not Submitted” and an output 456 of the aggregate of tracked data for a status of “Pending Approval” are displayed by expense tracker feature 450. A title 454, 458 may be provided to indicate which status 420 is associated with the output 452, 456. Utilizing process 300, the aggregate sum of the amounts of expense report objects 410 having a status of “Not Submitted” may be displayed as output 452 (indicated by arrows 460). Similarly, the aggregate sum of the amounts of expense report objects 410 having a status of “Pending Approval” may be displayed as output 456 (indicated by arrows 462). In some versions, expense tracker feature may include one or more feature, with which a user may interact. By way of example only, a dropdown menu, pop-up window, radio buttons, or the like may be used by a user to provide an indication of the status (or statuses) associated with the request for data to be tracked. Thus, a single output 452 may be displayed to the user by expense tracker feature 450 and the user may select the status desired for the data to be displayed. Of course, it should be understood that expense tracker feature 450 is merely an example and other data to be tracked and/or other features may be provided to utilize process 300 described herein.

In some implementations, expense buffer feature 470 may provide an indication of the number of expense items that have not been assigned. Expense buffer feature 470 may further include an output 472 that may provide an indication of the value of the unassigned expenses within expense buffer in accordance with process 300 described herein. Thus, a user may utilize output 472 to quickly determine the total value of expense items that have not been assigned from homepage user interface 400.

Similarly, non-reimbursable expenses feature 480 may provide an indication of the number of expense items that have not been assigned. Non-reimbursable expenses feature 480 may further include an output 482 that may provide an indication of the value of the non-reimbursable expenses in accordance with process 300 described herein. Thus, a user may utilize output 482 to quickly determine the total value of expense items that will not be reimbursed from homepage user interface 400.

Of course, further implementations and/or uses for the output of process 300 may be included in other features of homepage user interface 400 and/or otherwise.

These computer programs (e.g., programs, software, software applications or code), include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Controllers (PLCs) Programmable Logic Devices (PLDs)), used to provide machine instructions and/or data to a programmable processor. A “machine-readable medium” and “computer-readable medium” do not include transitory signals.

To provide for interaction with a user, the systems and techniques described here can be implemented on a computer having a display device (e.g., a CRT (cathode ray tube) or LCD (liquid crystal display) monitor), for displaying information to the user and a keyboard and a pointing device (e.g., a mouse or a trackball), by which the user can provide input to the computer. Other kinds of devices can be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The systems and techniques described here can be implemented in a computing system that includes a back-end component, a middleware component, or a front-end component, or any combination of back-end, middleware, or front-end components. The components of the system may be interconnected by any form or medium of digital data communication (e.g., a communication network). Examples of communication networks include a local area network (“LAN”), a wide area network (“WAN”), and the Internet.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for tracking amount data comprising:
receiving, at a processing circuit, a request for an amount sum associated with the status;
determining, at the processing circuit, one or more expense report objects associated with the status;
querying the determined one or more expense report objects associated with the status for one or more amount data elements;
receiving, at the processing circuit, the one or more amount data elements from the determined one or more expense report objects associated with the status; and
outputting the amount sum of the one or more amount data elements to a feature of a user interface.

2. The method of claim 1 further comprising displaying the amount sum using the feature of the user interface.

3. The method of claim 2, wherein the amount sum is a first amount sum, wherein the status is a first status, wherein the first amount sum is associated with the first status, the method further comprising displaying a second amount sum using the feature of the user interface, wherein the second amount sum is associated with a second status.

4. The method of claim 3, wherein the first status is indicative of an expense report object that has not been submitted.

5. The method of claim 4, wherein the second status is indicative of an expense report object that has not been approved.

6. The method of claim 5, wherein each expense report object of the one or more expense report objects comprises one or more associated expense items, wherein each associated expense item comprises an amount, wherein the amount data element of each expense report object comprises a sum of the amounts of the associated expense items.

7. The method of claim 2 further comprising transmitting a notification in response to the amount sum exceeding a threshold value.

8. A computer implemented method comprising:
receiving a request for an amount sum associated with a status of one or more expense items;
determining one or more expense items associated with the status;
querying the determined one or more expense items associated with the status for one or more amount data elements;
receiving the one or more amount data elements from the determined one or more expense items associated with the status; and
displaying the amount sum of the one or more amount data elements on a user interface.

9. The computer implemented method of claim 8, wherein the one or more expense items form an expense buffer.

10. The computer implemented method of claim 9, wherein the status is indicative of an expense item that has not been allocated to an expense report object.

11. The computer implemented method of claim 8, wherein the one or more expense items form a non-reimbursable buffer.

12. The computer implemented method of claim 11, wherein the status is indicative of an expense item will not be reimbursed.

13. A tangible computer-readable storage medium having instructions to display a feature for a graphical user interface, the instructions comprising instructions to:
receive a first request for a first data sum, wherein the first request is associated with a first status;
determine a first set of one or more data structures associated with the first status;
query each of the determined one or more data structures of the first set for a first data element;
generate a first output, wherein the first output is associated with the first status, and wherein the first output comprises a first sum of the returned first data elements; and
display the first output.

14. The computer readable storage medium of claim 13, wherein the one or more data structures comprise one or more expense items.

15. The computer readable storage medium of claim 13, wherein the first set of one or more data structures comprise a first set of one or more expense report objects.

16. The computer readable storage medium of claim 15, wherein the first data element comprises a first amount associated with a corresponding expense report object of the first set of one or more expense report objects.

17. The computer readable storage medium of claim 16, wherein the first status is selected from the group consisting of a status indicative of an expense report object that has not been submitted, a status indicative of an expense report object that has not been approved, a status indicative of an expense report object that has been approved, and a status indicative of an expense report object that has been paid.

18. The computer readable storage medium of claim 17 further comprising instructions to:
receive a second request for a second data sum, wherein the second request is associated with a second status;
determine a second set of one or more data structures associated with the second status;
query each of the determined one or more data structures of the second set for a second data element;
generate a second output, wherein the second output is associated with the second status, and wherein the second output comprises a second sum of the returned second data elements; and
display the second output.

19. The computer readable storage medium of claim 18, wherein the second set of one or more data structures comprise a second set of one or more expense report objects, wherein the second data element comprises a second amount associated with a corresponding expense report object of the second set of one or more expense report objects, and wherein the second status is selected from the group consisting of a status indicative of an expense report object that has not been submitted, a status indicative of an expense report object that has not been approved, a status indicative of an expense report object that has been approved, and a status indicative of an expense report object that has been paid.

20. The computer readable storage medium of claim 19, wherein the first status and the second status are different.
